(19) United States
(12) Patent Application Publication
(10) Pub. No.: US 2010/0035591 A1
(43) Pub. Date: Feb. 11, 2010

(54) METHOD AND SYSTEM FOR PROVIDING INFORMATION USING IDENTIFICATION NUMBER ALLOCATED TO COMMUNICATION NETWORK

(76) Inventor: Jong Min Park, Seoul (KR)

Correspondence Address: GWIPS;Peter T. Kwon, Gwacheon P.O. Box 72, 119 Byeolyang Ro, Gwacheon City, Gyeonggi-Do, 427-600, KR

(21) Appl. No.: 12/448,018

(22) PCT Filed: Dec. 7, 2007
(86) PCT No.: PCT/KR2007/006358

§ 371 Date: Jun. 4, 2009

(30) Foreign Application Priority Data
Dec. 8, 2006 (KR) 10-2006-0124959
May 16, 2007 (KR) 10-2007-0047522
Jun. 12, 2007 (KR) 10-2007-0057272

(51) Int. Cl. H04M 3/42

(52) U.S. Cl. 455/415

(57) ABSTRACT

A method and system for providing information for using an identification number, which is a user-by-user information DB, is provided to individual user when each user desires, thereby preventing inconvenience due to the indiscriminately provided information, and simultaneously providing and efficiently delivering the information to the providers. A system for providing information for using identification number comprising: a user terminal for calling an identification number corresponding to information of a user's interest; a user-by-user information DB constructed such that the user matches to information data of the user's interest; a server for setting and changing a correspondence relation between the user and information data of the user's interest in the user-by-user information DB according to an identification number call from the user terminal; and a message center for transmitting an interest information message corresponding to the information data of user's interest to the user terminal, responding to the request of server.

### TECHNICAL FIELD

The present invention relates to a method and system for providing information using an information element (e.g. a number or code) (hereinafter, referred to as an “identification number”) for identifying each user through a wired or wireless network, such as a telephone number through a public switched telephone network, an Internet telephone number through the Internet, a beeper number, etc., and more particularly to a method and system for providing information using an identification number allocated to a communication network, by which a user-by-user information DB is provided, and information is provided to each user at a time the user desires, thereby preventing users from being inconvenienced due to indiscriminately provided information, and simultaneously providing an efficient information delivery function to information providers.

### BACKGROUND ART

The prior art for implementing an idea to provide information using an identification number allocated to a communication network is disclosed in Korean patent application No. 10-2001-0012349 entitled “Internet advertisement method using symbol mark recorded together with telephone number inserted in off-line printed media” (hereinafter, referred to as “Application 12349”) and in Korean patent application No. 10-2001-0060219 entitled “System for searching for image information and detailed information using telephone number in advertisement of specified goods for sale” (hereinafter, referred to as “Application 60219”), in connection with advertisement information.

According to Application 12349, a service provider creates an advertiser-by-advertiser advertisement DB in a web server, and each advertiser distributes off-line printed media (i.e. advertisement papers) in which a specified symbol is recorded together with a telephone number of the advertiser. Thereafter, when a user searches for the telephone number through the web server by means of the Internet, the service provider extracts advertisement corresponding to the telephone number from the advertisement DB, and displays the extracted advertisement.

According to Application 60219, a service provider creates an advertisement DB according to goods for sale by each advertiser in a web server, and each advertiser distributes paper advertisements (i.e. advertisement papers) on which a telephone number of the advertiser is disclosed together with an advertisement for goods for sale. Thereafter, when a user searches for the telephone number through the web server by means of the Internet, the service provider displays advertisement including image information and detailed information, which have been associated with goods for sale corresponding to the telephone number.

As shown in FIG. 1, the conventional technologies are constructed in such a common manner that a database (i.e. an advertiser-by-advertiser advertisement DB) of advertisement data corresponding to a telephone number of each advertiser is created in a web server 130 of the service provider, and when a user accesses the web server 130 through the Internet 120 and searches for the telephone number by means of a user terminal 110, such as a personal computer (PC), advertisement data corresponding to the telephone number is provided.

However, according to the conventional technologies, after a user obtains information, such as a telephone number of an advertiser, the address of a web server through which the telephone number can be searched for, etc., through an off-line medium, such as an advertisement paper, in advance (step 1), the user must accesses the web server through the Internet (step 2), and must search for the telephone number (step 3).

Accordingly, the conventional technologies require complicated procedures to obtain desired information, and are inconvenient in that because different telephone numbers are used depending on each advertiser and each piece of goods for sale, the user must memorize all required telephone numbers when wanting to simultaneously search for a plurality of advertisements or goods for sale. In addition, the conventional technologies lack convenience of enabling the user to arrange and see only advertisements of his/her interest.

### DISCLOSURE OF INVENTION

### Technical Problem

Therefore, the present invention has been made in view of the above-mentioned problems, and it is an object of the present invention to provide a method and system for providing information using an identification number allocated to a communication network, by which the user can obtain desired information, such as advertisements, through only a simple procedure of pressing an identification number, such as a telephone number, on a mobile terminal, it is unnecessary for the user to be equipped with a separate means, other than a mobile terminal, to access an information DB, it is unnecessary for the user to memorize an information-related identification number (e.g. a telephone number associated with advertisement), it is possible to provide a user-oriented information provision service by providing a user-by-user interest information DB, and it is possible to provide information at the time desired by the user and in the manner desired by the user.

Also, it is another object of the present invention to provide a method and system for providing information using an identification number allocated to a communication network, which provides advertisement information to desired users at a desired time and manner, thereby maximizing the advertising effect of advertisers, and preventing the users from being inconvenienced due to spam advertisements.

Also, it is still another object of the present invention to provide a method and system for providing information using an identification number allocated to a communication network, by which the users can easily obtain desired information either free of charge or with a small fee made by communication connection, even if a fee is required, while being provided with the service using a mobile communication network, thereby easily drawing customers to the service.

In addition, it is still another object of the present invention to provide a method and system for providing information using an identification number allocated to a communication network, which enables the user to read desired information at a desired time, and in a desired manner.

According to an aspect of the present invention, there is provided a system for providing information using an identification number allocated to a communication network, the system including: a user terminal for calling an identification number corresponding to information of a user's interest; a user-by-user information DB constructed such that the user is matched to information data of the user's interest; a server for setting and changing a correspondence relation between the user and the information data of the user's interest in the user-by-user information DB according to an identification number call from the user terminal; and a message center for transmitting an interest information message corresponding to the information data of the user's interest to the user terminal, in response to a request of the server.

According to another aspect of the present invention, there is provided a method for providing information using an identification number allocated for a communication network in a system, which includes: a user terminal for calling an identification number corresponding to information of a user's interest; a user-by-user information DB constructed such that the user is matched to information data of the user's interest; a server for setting and changing a correspondence relation between the user and the information data of the user's interest in the user-by-user information DB according to an identification number call from the user terminal; and a message center for transmitting an interest information message corresponding to the information data of the user's interest to the user terminal, in response to a request of the server, the method including the steps of: receiving, by the server, an identification number call from the user terminal; creating, by the server, user information in the user-by-user information DB so that an originator number of the user terminal is matched to information data corresponding to the called identification number, according to the identification number call from the user terminal; and transmitting an information message corresponding to the information data to the user terminal.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating the configuration of a conventional advertisement system using telephone numbers;

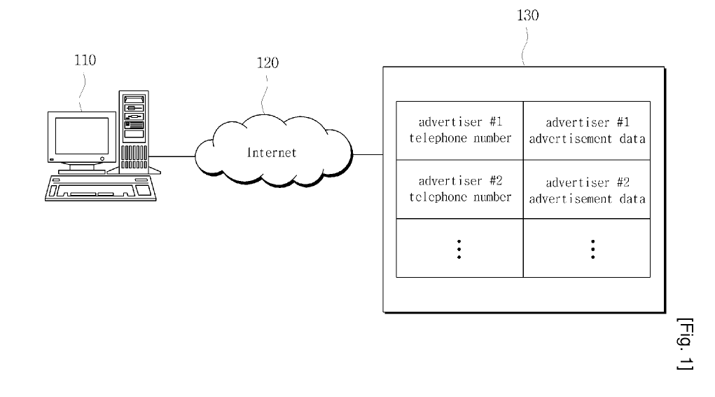

FIG. 2 is a view illustrating the configuration of an information provision system using an identification number allocated to a communication network according to an exemplary embodiment of the present invention; and

FIG. 3 is a flowchart illustrating an information provision method using an identification number allocated to a communication system according to an exemplary embodiment of the present invention.

### BEST MODE FOR CARRYING OUT THE INVENTION

Hereinafter, an exemplary embodiment of the present invention will be described with reference to the accompanying drawings. Although the following description will be given about advertisement information as a representative example to which the present invention can be applied, the present invention can be applied to various types of information, such as news, living information, shopping information, etc., in addition to the advertisement information.

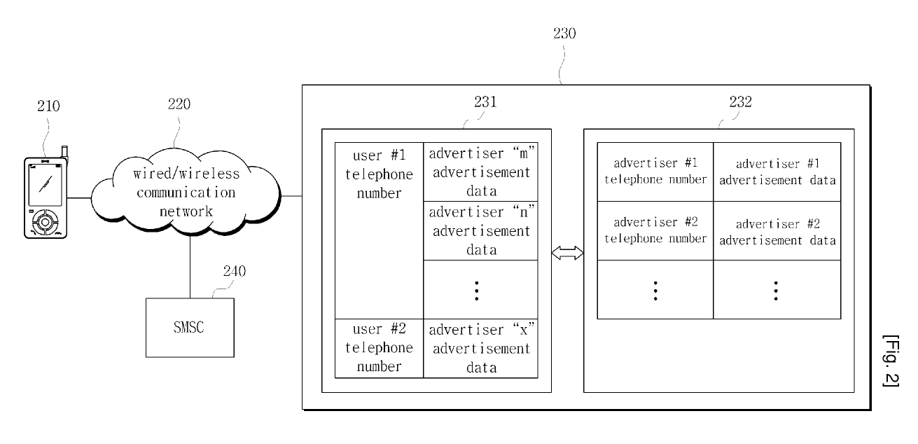

FIG. 2 is a view illustrating the configuration of an advertisement system using an identification number allocated to a communication network according to an exemplary embodiment of the present invention.

According to an exemplary embodiment of the present invention, the advertisement system using an identification number allocated to a communication network includes a mobile terminal 210, an advertisement information server 230 storing an advertisement DB, and a short message service center (SMSC) 240 for transmitting short messages based on the advertisement DB to the mobile terminal 210, in which the mobile terminal 210, the advertisement information server 230 and the SMSC 240 are connected to each other through a wired/wireless communication network 220. Meanwhile, the advertisement DB contained in the advertisement information server 230 includes a user-by-user advertisement DB 231, as well as an advertiser-by-advertiser advertisement DB 232.

Although an exemplary embodiment of the present invention is described mainly about the advertisement system which employs an easy service method using the mobile terminal 210, the present invention will be applied to even communication systems using a wireless telephone or wired telephone capable of receiving short messages, such as “Ann™” provided by KT Corporation.

The advertisement information server 230 functions not only as a DB server, which contains an advertisement DB including the user-by-user advertisement DB 231 and the advertiser-by-advertiser advertisement DB 232, but also as a communication server to connect the advertisement information server 230 to the wired/wireless communication network 220 (or when there is a separate DB server including an advertisement DB according to the implementation scheme of a system, as an advertisement information server connected to the separated DB server). The advertisement information server 230 is a component corresponding to the mobile terminal 210 capable of using the wired/wireless Internet. When the wired/wireless telephone is employed, the advertisement information server 230 should be expanded to include the concept of a server of a type corresponding to the wired/wireless telephone.

The SMSC 240 is connected to both the mobile terminal 210 and the advertisement information server 230 through the wired/wireless communication network 220, and functions to create a short message according to information from the advertisement information server 230, and to provide the created short message to the mobile terminal 210. Considering the recent tendency that either a separate multimedia messaging service center (MMSC) to process multimedia messaging service (MMS) messages is included in addition to the SMSC 240 or that the SMSC 240 and the MMSC are combined, and considering the objects of the present invention, the SMSC 240 should be understood as a message center of creating and transmitting all types of messages (hereinafter, referred to as Messages”) which include text messages, multimedia messages, voice messages, etc.

Meanwhile, since the advertisement DB contained in the advertisement information server 230 includes the user-by-user advertisement DB 231 and the advertiser-by-advertiser advertisement DB 232, the advertisement DB is different from a conventional advertiser-by-advertiser advertisement DB. That is, according to an exemplary embodiment of the present invention, not only the advertiser-by-advertiser advertisement DB 232 for an advertiser-centered advertisement service, but also the user-by-user advertisement DB 231 for a user-centered advertisement service are created, wherein only advertisements (e.g. advertisement data of advertiser “m,” advertisement data of advertiser “n,” etc.) registered as advertisements of each user's interest are extracted from the advertiser-by-advertiser advertisement DB 232 and are separately classified in the user-by-user advertisement DB 231.

In order to transmit an advertisement message in a desired form at a desired time according to options set by an advertiser or a user, to the mobile terminal 210 of the user through the SMSC 240, a means for separately recording only advertisements registered as advertisements of the user's interest is required, and one representative means therefor is the user-by-user advertisement DB 231.

Therefore, if a conventional advertiser-by-advertiser advertisement DB 232 is changed in such a manner as to add identifications for each user to the advertiser-by-advertiser advertisement DB 232 so that an advertisement message according to an option desired by a user can be transmitted, even without the separate user-by-user advertisement DB 231, it should be understood to be included within the scope of the present invention.

Meanwhile, the advertisement information server 230 is a web server having a wired/wireless transmission/reception function, and can function as a mail server. Therefore, when the user-by-user advertisement DB 231 is updated, the advertisement information server 230 may transmit the updated information through an e-mail, instead of a message, to the mobile terminal 210 or a user account of the advertisement information server 230, or may transmit the updated information in the form of web contents which can be identified through the user account.

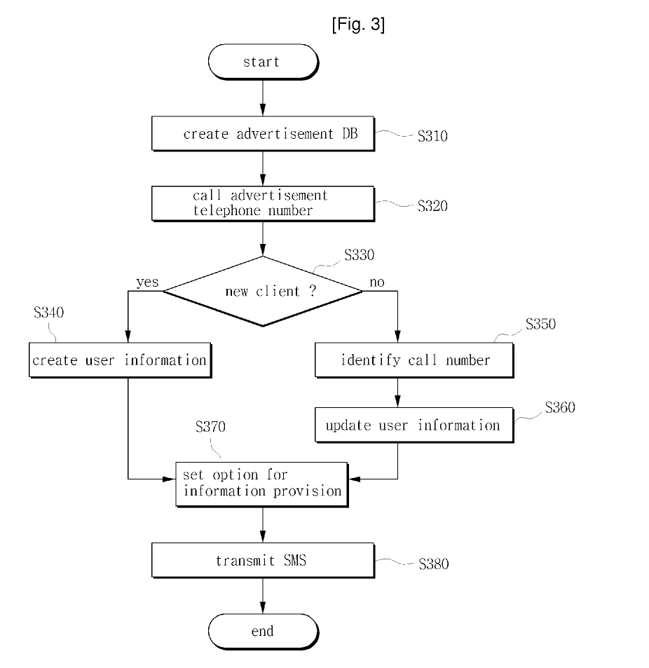

FIG. 3 is a flowchart illustrating an advertisement method using an identification number allocated to a communication system according to an exemplary embodiment of the present invention.

In order to perform the advertisement method according to an exemplary embodiment of the present invention, it is necessary for a service provider (hereinafter, referred to as a “Service provider”) of the present invention to determine the form of identification numbers allocated for the advertisement method of the present invention through a negotiation with a wired/wireless communication provider, or it is necessary for the service provider or wired/wireless communication provider to determine the form of identification numbers allocated for the advertisement method of the present invention when the service provider and the wired/wireless communication provider are identical to each other. Determining the form of identification numbers may include, for example, a procedure in which identification numbers (e.g. 1577-XXXX, 0XX-XXX-XXXX, etc.) of a specified band are allocated as numbers for the advertisement service according to the present invention. Through such a procedure, the stage is set for transferring a call (or paging) of an identification number in the specified band to the advertisement information server 230 in the wired/wireless communication network 220, which includes various communication networks containing a mobile communication system and the wired/wireless Internet.

Then, it is necessary, in the advertisement information server 230, to create the advertisement DB 232 in which advertisement data is recorded. Such an advertisement DB may be constructed in such a manner that advertisement data for each advertiser is composed according to the order of the advertiser under negotiation between a service provider and the advertiser, as in the prior art, or that an advertiser calls a predetermined identification number and transmits advertisement data stored in the mobile terminal 210 of the advertiser to the advertisement information server 230 through the wired/wireless communication network 220, and the advertisement information server 230 receives and records the advertisement data in the advertiser-by-advertiser advertisement DB 232, based on the characteristic of the present invention in which data can be updated on-line, or that advertisement data is recorded through a separate web server (step 310).

After advance preparations have finished on-line/off-line, as described above, the advertiser records an identification number of a predetermined form according to the present invention on a signboard or advertisement of a business operated by the advertiser, or on products advertised on-line or off-line by the advertiser.

Then, a person, who sees the signboard or advertisement, calls the identification number recorded on the advertisement of the business by means of his/her own mobile terminal 210, thereby accessing the advertisement information server 230 through the wired/wireless communication network 220 (step 320). For example, in comparison with a method in which persons separately take a memo of an associated identification number when seeing an interesting product or advertisement of an interesting business on the way to somewhere, and then search the Internet therefor, persons can immediately and easily access the advertisement information server 230 by directly pressing the identification number recorded on an interesting business's signboard, product or advertisement then and there (or by photographing and storing the identification number in the case of a terminal, such as a camera-phone having a character recognition function).

According to the present invention, an access to the advertisement information server 230 is regarded as a registration of the user, and a registration of the advertisement associated with the corresponding identification number as an advertisement of the user's interest. That is, the advertisement information server 230 checks the originating number of a caller of a terminated communication call based on a terminating trigger function during communication (including an initial communication connection process) or after the communication has finished, and determines if the caller corresponds to one of users recorded in the user-by-user advertisement DB 231 (step 330). When it is determined that the caller does not correspond to any one of users recorded in the user-by-user advertisement DB 231 (i.e. when it is determined that the caller corresponds to a new client) as a result of the determination, a user-by-user advertisement DB 231 in which the originating number and the called identification number are matched to each other is created with regard to the originating number (step 340).

Meanwhile, when a caller listens to a ring-back tone after paging an identification number, after the caller listens to a service guidance comment corresponding to the ring-back tone, or directly after a telephone call has finished, the caller transfers his/her own originating number to the advertisement information server 230 with the terminating trigger function, through a communication call connection by a switching system. Also, a caller may finish a call directly after the caller listens to only a ring-back tone (or a service guidance comment which replaces the ring-back tone), during which only an originating number is transferred, with no fee charged. In this case, the advertisement information server 230 and the wired/wireless communication network 220 should be operated so as not to connect the call of the caller to communication charging a fee.

Through such a procedure, the user registers advertisements of his/her interest in the user-by-user advertisement DB 231 contained in the advertisement information server 230, so that the user can be provided with information about the advertisements of his/her interest.

As described above, it is preferred that the present invention is implemented in such a manner as not to charge a fee to the user, but the present invention may be implemented in such a manner as to charge a fee to the user according to the design of the system so as to prevent malicious or indiscreet non-charged information use.

Meanwhile, according to a general type of service, a corresponding advertisement message is transmitted to a user, who has registered an advertisement of his/her interest, at least once during a predetermined period of time. However, selectively, when option setting is permitted in the advertisement information server 230 and the wired/wireless communication network 220, the user establishes a communication call through a preset button or the like after the ring-back tone (or service guidance comment) has finished, accesses the advertisement information server 230, and sets an information provision option to receive a service in a desired scheme (step 370).

The information provision option may include, for example, an advertisement message reception approval/disapproval setting (which enables the user to obtain only a minimum of information sources about a corresponding advertisement through a registration of an advertisement of his/her interest, or to reject reception of advertisement messages), an advertisement message reception disapproval time setting (which enables the user to set a period of time during which the user does not wish to receive advertisement messages), a setting of a delay time until an initial advertisement message is transmitted after a registration of an advertisement of interest (wherein, since a corresponding advertisement is automatically transmitted within a predetermined period of time after a registration of an advertisement of interest, it is necessary to adjust the predetermined period of time), an advertisement message interface setting (which enables the user to select an SMS or MMS, or to determine whether or not the advertisement message includes a picture or map), a spam advertisement message type setting (which enables the user to register types of spam advertisement messages in advance to prevent a case where a registration of an advertisement of interest and/or message transmission is mistaken), a setting about whether to receive an updated advertisement message for a long time (which enables the user, when an advertisement of his/her interest is periodically updated, to continuously receive the updated advertisement message during a set time period without a separate additional arrangement), a setting about whether to perform user identification before an advertisement message is transmitted (which is used when user authentication is required before reception of an advertisement message in order to prevent other persons from seeing advertisement messages desired by the user), an interest-advertisement-related memo setting (which enables the user to record information only for himself/herself, such as a place or time at which the user sees an advertisement of his/her interest), and a setting for an advertisement server through a separate web server (which enables the user to set an advertisement to be received through a user account of a web server, either together with a mobile message or instead of the mobile message). To this end, it is necessary to additionally provide information provision option information to the user-by-user advertisement DB 231 or the advertiser-by-advertiser advertisement DB 232.

When a client, who has registered once, calls another telephone associated with the advertisement method according to the present invention (step 320), the advertisement information server 230 checks the originating number of the client and identifies that the client is one of users recorded in the user-by-user advertisement DB 231 (step 330). Then, the advertisement information server 230 identifies an identification number called by the user (step 350), searches the advertiser-by-advertiser advertisement DB 232 for advertisement data corresponding to the called identification number, and updates the user-by-user advertisement DB 231 so that the searched advertisement data is matched to the user (step 360).

Next, an information provision option setting function of enabling the user or a dvertiser to set a new option or to change a set option may be selectively provided (step 370). In this case, it is preferred that the information provision option setting function is provided by a setting function through the Internet or an ARS system.

Finally, when a user DB has first been created in step 340, or when a user DB has been updated in step 360, the advertisement information server 230 creates and transmits an advertisement message desired by the user to the mobile terminal 210 of the user by using the SMSC 240 (or provides an advertisement using e-mail and/or web contents), according to an advertisement message forwarding schedule set by itself or according to an option set by the user in step 370.

Meanwhile, according to the design of the entire wired/wireless communication network including the advertisement information server 230 and the SMSC 240,

the present invention can be implemented in such a manner that the advertisement message forwarding schedule set by a service provider and/or the advertisement message forwarding schedule set by an information provision option is stored in the SMSC 240, instead of the advertisement information server 230, wherein such a change must be appropriately performed according to the implementation scheme of each communication system.

That is, as described above, the advertisement information server 230 is located outside, together with the switching system and the SMSC 240, in which, when a caller who desires to receive information makes a call through a wired/wireless communication network (a telephone network, the Internet, etc.), the communication call is delivered through the switching system, thereby transmitting an originating number, which is detected based on the terminating trigger, to the advertisement information server 230. Accordingly, the advertisement information server 230 provides advertisement information, which is extracted based on the called identification number and the detected originating number, to the originating number by using the SMSC 240.

However, the present invention is not limited to such a construction. As a first example, the present invention may be implemented in a structure in which a service provider having a terminal (a normal telephone, an Internet telephone, a beeper, etc.) with an identification number includes a CID repeater for detecting an originating number based on the terminating trigger. In this case, the service provider transmits an originating number detected through the CID repeater, together with the identification number of the service provider, to the advertisement information server 230. Then, the advertisement information server 230 provides advertisement information based on the called identification number and the originating number to the originating number by using the SMSC 240. According to the first example, since service users who desire to receive advertisement information access the advertisement information server 230 through CID repeaters of each service provider, it is not required that the advertisement information server 230 switches telephone communication lines as many as the number of identification numbers generated by every service user. In addition, since each service provider includes and installs a CID repeater, each identifier (ID) for service provision has a high relation with the identification number of the corresponding service provider, thereby providing convenience to service users in using advertisement contents provided by the service provider.

In a second example, the present invention may be implemented in a structure in which each service provider having a terminal with an identification number includes the advertisement information server 230, as well as the CID repeater. In this case, each service provider directly detects an originating number through the CID repeater, and provides advertisement information, which the service provider has, corresponding to the detected originating number to the originating number by using the SMSC 240. According to the second example, since each service provider directly stores advertisement information, there are advantages in that it is convenient to correct and update the stored advertisement and to add new advertisement information, in addition to the advantage provided by the first example.

In addition, it should be noted that when each service provider includes the CID repeater, the advertisement information server and the SMSC, together with a terminal having an identification number, the CID repeater, the advertisement information server, and the SMSC may be separately constructed as independent devices, or may be integrally constructed as one device (i.e. a device including the terminal, the CID repeater, the advertisement information server, and the SMSC).

As described above, when a system is constructed in such a manner that a caller desiring to receive information makes a call through a wired/wireless communication network (a telephone network, the Internet, etc.), and advertisement information is selected based on a called identification number and an originating number detected through a communication call connection and is provided to the detected originating number, the system should be understood as included in the scope of the present invention.

While the present invention has been shown and described with reference to certain exemplary embodiments thereof, it will be understood by those skilled in the art that the invention is not limited to the disclosed embodiment and the drawings, and various changes in form and details may be made therein without departing from the spirit and scope of the invention as defined by the appended claims. Particularly, although the embodiments of the prevention invention have been described about advertisement information as a representative example, to which the present invention can be applied, the present invention can be applied to various types of information including news, living information, and shopping information, as well as the advertisement information. In this case, the procedure of pressing an identification number recorded on an advertisement will be replaced by a procedure of pressing an identification number provided together with another type of information, such as news, living information, shopping information, etc., or by a procedure of pressing a corresponding identification number contained in a separate medium including the information.

### INDUSTRIAL APPLICABILITY

According to the method and system for providing information using an identification number based on the present invention, the user can obtain desired information, such as advertisements, through only a simple procedure of pressing an identification number on a mobile terminal, it is unnecessary for the user to be equipped with a separate means, other than a mobile terminal, to access an information DB, it is unnecessary for the user to memorize an information-related identification number (e.g. an identification number associated with advertisement), it is possible to provide a user-oriented information provision service by providing a user-by-user interest information DB, and it is possible to provide information at the time desired by the user and in the manner desired by the user.

Also, according to the method and system for providing information using an identification number based on the present invention, advertisement information is provided to desired users at a desired time and manner, thereby maximizing the advertising effect of advertisers, and preventing the users from being inconvenienced due to spam advertisements.

Also, according to the method and system for providing information using an identification number based on the present invention, the users can easily obtain desired information either free of charge or with a small fee made by communication connection, even if a fee is required, while being provided with the service using a mobile communication network, thereby easily drawing customers to the service.

In addition, according to the method and system for providing information using an identification number based on the present invention, the user can read desired information at a desired time, and in a desired manner.

What is claimed is:

1-12. (canceled)

13. A system for providing information for using an identification number allocated to a communication network, the system comprising:
a user terminal for calling an identification number corresponding to information of a user's interest;
a user-by-user information DB constructed such that the user is matched to information data of the user's interest;
a server for setting and changing a correspondence relation between the user and the information data of the user's interest in the user-by-user information DB according to an identification number call from the user terminal; and
a message center for transmitting an interest information message corresponding to the information data of the user's interest to the user terminal, in response to a request of the server.

14. The system as claimed in claim 13, wherein the server identifies an originator number corresponding to the identification number call generated from the user terminal, and matches the originator number of the user terminal and information data corresponding to the called identification number to the user and the information data of the user's interest, respectively.

15. The system as claimed in claim 14, further comprising an information DB (hereinafter, referred to as a “provider-by-provider information DB”) for each information provider, which is connected to the user-by-user information DB and stores information data according to each information provider, wherein the server searches the provider-by-provider information DB for information data corresponding to the called identification number, matches the searched information data to the originator number of the user terminal, thereby constructing a correspondence relation between the user and the information data of the user's interest.

16. A method for providing information using an identification number allocated for a communication network in a system, which comprises: a user terminal for calling an identification number corresponding to information of a user's interest; a user-by-user information DB constructed such that the user is matched to information data of the user's interest; a server for setting and changing a correspondence relation between the user and the information data of the user's interest in the user-by-user information DB according to an identification number call from the user terminal; and a message center for transmitting an interest information message corresponding to the information data of the user's interest to the user terminal, in response to a request of the server, the method comprising the steps of:
receiving, by the server, an identification number call from the user terminal;
creating, correcting or adding, by the server, user information in the user-by-user information DB so that an originator number of the user terminal is matched to information data corresponding to the called identification number, according to the identification number call from the user terminal; and
transmitting an information message corresponding to the information data to the user terminal.

17. The method as claimed in claim 16, further comprising the steps of:
providing, by the server, a ring-back tone or a guidance comment corresponding to the ring-back tone to the user terminal in response to the identification number call from the user terminal; and
ending the identification number call from the user terminal after the originator number has been identified.

18. The method as claimed in claim 16, further comprising the steps of:
searching, by the server, the user-by-user information DB for the originator number of the user terminal according to a different identification number call from the user terminal; and
updating the user information in the user-by-user information DB such that the originator number is matched to different information data corresponding to the called different identification number when it is determined that the originator number has been stored in the user-by-user information DB as a result of the search.

19. The method as claimed in claim 18, wherein the information message includes a short message and a multimedia message.

20. The method as claimed in claim 16, further comprising, after the step of creating the user information, a step of setting an information provision option associated with transmission of the information message by using the user terminal.

21. The method as claimed in claim 18, further comprising, after the step of updating the user information, a step of setting an information provision option associated with transmission of the information message by using the user terminal.

22. A method for providing information using an identification number allocated for a communication network in a system, which comprises: a user terminal for calling an identification number corresponding to information of a user's interest; a user-by-user information DB constructed such that the user is matched to information data of the user's interest; an information DB (hereinafter, referred to as a “provider-by-provider information DB”) for each information provider which is connected to the user-by-user information DB and stores information data according to each information provider; a server for searching the provider-by-provider information DB for information data corresponding to a called identification number when the identification number is called from the user terminal, and setting the searched information data as information data of the user's interest in the user-by-user information DB; and a message center for transmitting an interest information message corresponding to the information data of the user's interest to the user terminal, in response to a request of the server, the method comprising the steps of:
receiving, by the server, a call for a predetermined identification number of an information provider through the user terminal, and information data stored in the user terminal; and
storing, by the server, the information data received from the user terminal in the provider-by-provider information DB.

23. The method as claimed in claim 22, wherein, in the information data storing step, the server identifies the predetermined identification number, and stores an originator number of the user terminal and the received information data in the provider-by-provider information DB in such a manner that the originator number is matched to the received information data.
